(19) United States
(12) Patent Application Publication
(10) Pub. No.: US 2024/0414460 A1
(43) Pub. Date: Dec. 12, 2024

(54) OPTICAL DISTRIBUTION NETWORK APPARATUS AND SIGNAL PROCESSING METHOD

(71) Applicant: HUAWEI TECHNOLOGIES CO., LTD., Shenzhen (CN)

(72) Inventors: Zhicheng Ye, Dongguan (CN); Benbo Xu, Shenzhen (CN); Zongzhao Zheng, Dongguan (CN); Tianhai Chang, Dongguan (CN)

(73) Assignee: HUAWEI TECHNOLOGIES CO., LTD., Shenzhen (CN)

(21) Appl. No.: 18/814,387

(22) Filed: Aug. 23, 2024

Related U.S. Application Data
(63) Continuation of application No. PCT/CN2023/077920, filed on Feb. 23, 2023.

(30) Foreign Application Priority Data
Feb. 23, 2022 (CN) 202210170122.X

(51) Int. Cl. H04Q 11/00; H04B 10/27

(52) U.S. Cl. CPC H04Q 11/0062; H04B 10/27

(57) ABSTRACT

An optical distribution network ODN apparatus includes an optical splitting module, a control chip, a first optical port connected to the OLT, a second optical port connected to a next-level ODN apparatus, and a plurality of third photoelectric composite ports connected to the plurality of ONUs. The control chip sends a plurality of electrical signals that carry the port identification information to the plurality of corresponding ONUs. The optical splitting module performs power splitting on a first optical signal sent by the OLT to obtain a second optical signal transmitted to the next-level ODN apparatus and a plurality of third optical signals transmitted to the plurality of ONUs. The optical splitting module can be further configured to separately receive upstream optical signals of the plurality of corresponding ONUs and to transmit the upstream optical signals carrying identification information of the ONUs to the OLT.

### CROSS-REFERENCE TO RELATED APPLICATIONS

This application is a continuation of International Application No. PCT/CN2023/077920 filed on Feb. 23, 2023, which claims priority to Chinese Patent Application No. 202210170122.X filed on Feb. 23, 2022. The disclosures of the aforementioned applications are hereby incorporated by reference in their entireties.

### TECHNICAL FIELD

Disclosed embodiments relate to the signal processing field, and in particular, to an optical distribution network apparatus and a signal processing method.

### BACKGROUND

In a passive optical network (PON) system, an OLT transmits one downstream optical signal to a plurality of optical network units (ONUs) through power splitting and transmission of the downstream optical signal performed by an optical distribution network (ODN) apparatus, so that one-to-many optical interconnection is implemented.

In the PON system, the ODN apparatus includes a plurality of optical splitters, and transmits, through power splitting on an optical signal performed by a plurality of optical splitters with a fixed split ratio and transmission in an optical cable, an optical signal sent by one optical line terminal OLT to the plurality of ONUs. For example, one PON network includes four ODN apparatuses. Each ODN apparatus has one input port and nine output ports. Four ODN apparatuses are sequentially connected in series, one of nine output ports of an optical splitter at first three levels is connected to an input port of a next-level optical splitter, and other output ports are connected to eight ONUs. In this way, a 1:32 PON system is formed. The optical splitter at the first three levels distributes, according to a fixed split ratio of 7:3, 70% optical energy of a received optical signal to the next-level optical splitter, and 30% optical energy to remaining eight output ports connected to the ONUs. In this way, it is ensured that an optical signal output by a last-level optical splitter meets a requirement of a connected ONU.

In a conventional technology, the ODN apparatus only transmits, through power splitting and transmission in the optical cable, the optical signal sent by the OLT to the plurality of ONUs, but the OLT cannot determine network topology information in an entire PON network.

### SUMMARY

Embodiments of this application provide an optical distribution network apparatus and a signal processing method, to transmit information such as identification information of a plurality of ONUs and port identification information to an OLT by using the ODN apparatus. The information such as the identification information of the plurality of ONUs and the port identification information is used by the OLT to determine network topology information of a PON system.

According to a first aspect, an embodiment of this disclosure provides an optical distribution network ODN apparatus. The ODN apparatus includes an optical splitting module, a control chip, a first optical port, a second optical port, and a plurality of third photoelectric composite ports, where the optical splitting module is connected to the control chip, the first optical port, the second optical port, and the plurality of third photoelectric composite ports. The first optical port is configured to connect to an optical line terminal OLT, and transmit an optical signal between the ODN apparatus and the OLT. The second optical port is configured to connect to a next-level ODN apparatus, and transmit an optical signal between the ODN apparatus and the next-level ODN apparatus. The plurality of third photoelectric composite ports are configured to connect to a plurality of ONUs, and transmit optical signals and electrical signals between the ODN apparatus and the plurality of ONUs. The third photoelectric composite port is a port that can simultaneously transmit an optical signal and an electrical signal. The control chip is configured to control the plurality of third photoelectric composite ports to send a plurality of electrical signals that carry port identification information to the plurality of corresponding ONUs, where the port identification information indicates identifiers of the plurality of third photoelectric composite ports. The optical splitting module is configured to perform power splitting on a first optical signal sent by the OLT to obtain a second optical signal and a plurality of third optical signals, where the second optical signal is transmitted to the next-level ODN apparatus, and the plurality of third optical signals are transmitted to the plurality of ONUs. The optical splitting module is further configured to: separately receive upstream optical signals of the plurality of corresponding ONUs from the plurality of third photoelectric composite ports, and transmit the upstream optical signals to the OLT, where the upstream optical signals carry identification information of the ONUs that send the upstream optical signals and port identification information of the corresponding third photoelectric composite ports that transmit the upstream optical signals.

In this possible implementation, the ODN apparatus transmits information such as identification information of the plurality of ONUs and port identification information to the OLT, so that the OLT determines network topology information based on the information such as the identification information of the plurality of ONUs and the port identification information. The network topology information includes a correspondence between the plurality of ONUs and the plurality of third photoelectric ports.

In a possible implementation of the first aspect, the ODN apparatus further includes a first optical power monitor optical power monitor (MPD), and the first MPD is connected to the first optical port. The first MPD is configured to: obtain a first optical power of the first optical signal, and transmit the first optical power to the control chip. The control chip is further configured to control at least one third photoelectric composite port of the plurality of third photoelectric composite ports to send at least one electrical signal that carries the first optical power to at least one ONU of the plurality of ONUs, where the at least one third photoelectric composite port corresponds to the at least one ONU. The optical splitting module is further configured to: separately receive an upstream optical signal of the at least one ONU from the plurality of third photoelectric composite ports, and transmit the upstream optical signal to the OLT, where the upstream optical signal of the at least one ONU carries the first optical power. The optical splitting module is further configured to: separately receive an upstream optical signal of the next-level ODN apparatus from the second optical port, and transmit the upstream optical signal to the OLT, where the upstream optical signal of the next-level ODN apparatus carries a first optical power of the next-level ODN apparatus.

In a possible implementation of the first aspect, the upstream optical signal of the at least one ONU further carries a downstream optical power received by the at least one ONU, and the upstream optical signal of the next-level ODN apparatus further carries downstream optical powers received by a plurality of ONUs connected to the next-level ODN apparatus.

In this possible implementation, the ODN apparatus transmits, to the OLT, the first optical power of the ODN apparatus, the first optical power of the next-level ODN apparatus, the downstream optical powers received by the plurality of ONUs connected to the ODN apparatus, and the downstream optical powers received by the plurality of ONUs connected to the next-level ODN, so that the OLT can determine the network topology information based on these pieces of power information. The network topology information further includes level information of the ODN apparatus and information about levels to which the plurality of ONUs belong.

In a possible implementation of the first aspect, the ODN apparatus further includes a second MPD and a third MPD, the second MPD is connected to the second optical port, and the third MPD is connected to the plurality of third photoelectric ports. The second MPD is configured to: obtain a second optical power of the second optical signal, and transmit the second optical power to the control chip. The third MPD is configured to: obtain third optical power of the plurality of third optical signals, and transmit the third optical power to the control chip. The control chip is further configured to control at least one third photoelectric composite port of the plurality of third photoelectric composite ports to send at least one electrical signal that carries the second optical power and the third optical powers to at least one ONU of the plurality of ONUs, where the at least one third photoelectric composite port corresponds to the at least one ONU. The optical splitting module is further configured to: separately receive an upstream optical signal of the at least one corresponding ONU from the plurality of third photoelectric composite ports, and transmit the upstream optical signal to the OLT. The upstream optical signal carries the first optical power, the second optical power, the third optical powers, and the downstream optical powers received by the plurality of ONUs.

In a possible implementation of the first aspect, the ODN apparatus further includes a first filter, a second filter, and a third filter. The first MPD is connected to the optical splitting module through the first filter, the second MPD is connected to the optical splitting module through the second filter, and the third MPD is connected to the optical splitting module through the third filter. The first filter is configured to filter an optical signal received by the first MPD. The second filter is configured to filter an optical signal received by the second MPD. The third filter is configured to filter an optical signal received by the third MPD. In this possible implementation, the OLT may determine an optical power loss based on these pieces of obtained power information. The optical power loss includes an optical power loss from the OLT to the ODN apparatus, optical power losses from the first optical port to the second optical port and the third photoelectric port, and optical power losses from the third photoelectric ports to the plurality of ONUs.

In a possible implementation of the first aspect, the optical splitting module includes a first optical splitter and an even ratio optical splitter, and an output port of the first optical splitter is connected to an input port of the even ratio optical splitter. The equal ratio optical splitter is an optical splitter that performs power splitting on an input optical signal to obtain a plurality of output optical signals with equal optical powers. The first optical splitter is configured to perform power splitting on the first optical signal to obtain the second optical signal and a fourth optical signal. The equal ratio optical splitter is configured to perform power splitting on the fourth optical signal to obtain the plurality of third optical signals.

In a possible implementation of the first aspect, the first optical splitter is an adjustable optical splitter. The adjustable optical splitter is an optical splitter whose power splitting ratio is adjustable.

In this possible implementation, the first optical splitter is the adjustable optical splitter. Therefore, an optical power ratio of the second optical signal and an optical power ratio of the plurality of third optical signals may be simply and efficiently adjusted by directly adjusting a split ratio of the first optical splitter.

According to a second aspect, an embodiment of this disclosure provides a signal processing method. The method is applied to an ODN apparatus, and the ODN apparatus is connected to an OLT, a plurality of ONUs, and a next-level ODN apparatus. The method includes: An ODN apparatus receives a first optical signal sent by an optical line terminal OLT. The ODN apparatus performs power splitting on the first optical signal to obtain a second optical signal and a plurality of third optical signals. The ODN apparatus transmits the second optical signal to a next-level ODN apparatus, and separately transmits the plurality of third optical signals to a plurality of corresponding ONUs. The ODN apparatus separately sends a plurality of electrical signals that carry port identification information to the plurality of corresponding ONUs, where the port identification information indicates identifiers of a plurality of third photoelectric composite ports. The ODN apparatus separately receives upstream optical signals of the plurality of ONUs, and transmits the upstream optical signals to the OLT, where the upstream optical signals carry identification information of the ONUs that send the upstream optical signals and port identification information of the corresponding third photoelectric composite ports that transmit the upstream optical signals, the upstream optical signals are for determining network topology information. The network topology information includes a correspondence between the plurality of ONUs and the plurality of third photoelectric ports.

In this possible implementation, the ODN apparatus transmits information such as identification information of the plurality of ONUs and port identification information to the OLT, so that the OLT determines network topology information based on the information such as the identification information of the plurality of ONUs and the port identification information. The network topology information includes a correspondence between the plurality of ONUs and the plurality of third photoelectric ports.

In a possible implementation of the second aspect, the method further includes: The ODN apparatus obtains a first optical power of the first optical signal. The ODN apparatus separately sends at least one electrical signal that carries the first optical power to at least one ONU of the plurality of ONUs. The ODN apparatus separately receives an upstream optical signal of the at least one ONU, and transmits the upstream optical signal to the OLT, where the upstream optical signal of the at least one ONU carries the first optical power. The ODN apparatus receives an upstream optical signal of the next-level ODN apparatus and transmits the upstream optical signal to the OLT, where the upstream optical signal of the next-level ODN apparatus carries a first optical power of the next-level ODN apparatus, and the upstream optical signal of the at least one ONU is for determining network topology information. The network topology information includes level information of the ODN apparatus and information about levels to which the plurality of ONUs belong.

In a possible implementation of the second aspect, the upstream optical signal of the at least one ONU further carries a downstream optical power received by the at least one ONU, and the upstream optical signal of the next-level ODN apparatus further carries downstream optical powers received by a plurality of ONUs connected to the next-level ODN apparatus.

In this possible implementation, the ODN apparatus transmits, to the OLT, the first optical power of the ODN apparatus, the first optical power of the next-level ODN apparatus. The downstream optical powers received by the plurality of ONUs connected to the ODN apparatus, and the downstream optical powers received by the plurality of ONUs connected to the next-level ODN are transmitted to the OLT, so that the OLT can determine more network topology information based on these pieces of power information. The network topology information further includes the level information of the ODN apparatus and the information about the levels to which the plurality of ONUs belong.

In a possible implementation of the second aspect, the method further includes: The ODN apparatus obtains a second optical power of the second optical signal. The ODN apparatus obtains third optical powers of the plurality of third optical signals. The ODN apparatus separately sends a plurality of electrical signals that carry the second optical power and the third optical powers to the plurality of ONUs. The ODN apparatus separately receives upstream optical signals of the plurality of corresponding ONUs, and transmits the upstream optical signals to the OLT. The upstream optical signal carries the first optical power, the second optical power, the third optical powers, and the downstream optical powers received by the plurality of ONUs. The upstream optical signal is for determining an optical power loss, where the optical power loss includes an optical power loss from the OLT to the ODN apparatus, optical power losses from a first optical port to a second optical port and a third photoelectric port, and optical power losses from the third photoelectric ports to the plurality of ONUs.

In this possible implementation, the ODN apparatus further sends the first optical power, the second optical power, the third optical powers, and the downstream optical powers received by the plurality of ONUs to the OLT. In this way, the OLT can determine the optical power loss based on these pieces of power information. The optical power loss includes an optical power loss from the OLT to the ODN apparatus, optical power losses from the first optical port to the second optical port and the third photoelectric port, and optical power losses from the third photoelectric ports to the plurality of ONUs.

In a possible implementation of the second aspect, the ODN apparatus includes a first optical splitter and an equal ratio optical splitter, and the performing, by the ODN apparatus, power splitting on the first optical signal to obtain a second optical signal and a plurality of third optical signals includes: The ODN apparatus performs power splitting on the first optical signal to obtain the second optical signal and a fourth optical signal by using the first optical splitter. The ODN apparatus performs power splitting on the fourth optical signal to obtain the plurality of third optical signals with equal optical powers by using the equal ratio optical splitter.

In this possible implementation, the optical splitting module performs power splitting on the first optical signal to obtain the second optical signal and the plurality of third optical signals by using the first optical splitter and the equal ratio optical splitter, and may directly determine an optical power ratio of the second optical signal and the plurality of third optical signals through an optical splitting ratio of the first optical splitter. The equal ratio optical splitter performs power splitting on the fourth optical signal to obtain the plurality of third optical signals, to provide the plurality of third optical signals with equal optical powers to the plurality of ONUs.

In a possible implementation of the second aspect, the first optical splitter is an optical splitter whose power splitting ratio is adjustable, and the method further includes: The ODN apparatus receives first upstream optical signals sent by the plurality of ONUs, and transmits the first upstream optical signals to the OLT through the first optical port. The first upstream optical signals carry network address information of the plurality of ONUs and a plurality of first downstream optical powers received by the plurality of ONUs. The ODN apparatus receives a downstream optical signal sent by the OLT, and sends the downstream optical signal to a target ONU indicated by the downstream optical signal. The downstream optical signal carries an adjustment signal, and the target ONU is an ONU that has a lowest first downstream optical power and that of the plurality of ONUs determined by the OLT. The ODN apparatus receives an electrical signal that is sent by the target ONU and that carries the adjustment signal, where the adjustment signal indicates the ODN apparatus to adjust the adjustable optical splitter, to increase an optical power of a target third optical signal output by a target third photoelectric port. The target third photoelectric port and the target third optical signal correspond to the target ONU.

In this possible implementation, the optical split ratio of the adjustable optical splitter is adjusted, to increase the optical power of the downstream optical signal received by the target ONU. This step is performed for a plurality of times, so that powers of optical signals received by the plurality of ONUs in an entire system are more balanced.

In a possible implementation of the second aspect, the method further includes: The ODN apparatus receives second upstream optical signals sent by the plurality of ONUs, and transmits the second upstream optical signals to the OLT. The second upstream optical signals carry the network address information of the plurality of ONUs and second downstream optical powers received by the plurality of ONUs. The first upstream optical signal and the second upstream optical signal are for determining the network topology information, where the network topology information further includes the level information of the ODN apparatus.

In this possible implementation, the ODN apparatus transmits the first upstream optical signal and the second upstream optical signal to the OLT. In this way, the OLT may determine the network topology information based on the network address information of the plurality of ONUs, the plurality of first downstream optical powers received by the plurality of ONUs, and the second downstream optical powers received by the plurality of ONUs that are carried in the first upstream optical signal and the second upstream optical signal. The network topology information includes the level information of the ODN apparatus.

According to a third aspect, an embodiment of this disclosure provides a signal processing method. The method is applied to an OLT, where the OLT is connected to an ODN apparatus, and the ODN apparatus is connected to a next-level ODN apparatus and a plurality of ONUs. The method includes: The OLT sends a first optical signal to the optical distribution network ODN apparatus. The OLT receives a plurality of upstream optical signals that are sent by a plurality of ONUs and that are transmitted by the ODN apparatus, where the plurality of upstream optical signals carry port identification information and a plurality of pieces of network address information of the plurality of corresponding ONUs. The port identification information indicates identifiers of a plurality of third photoelectric ports that are connected to the plurality of ONUs and that are of the ODN apparatus. The OLT determines network topology information based on the port identification information and the plurality of pieces of network address information, where the network topology information includes information about a correspondence between the plurality of ONUs and the plurality of third photoelectric ports.

In this possible implementation, the OLT receives information such as identification information of the plurality of ONUs and port identification information that are sent by the ODN apparatus, and then may determine the network topology information based on the information such as the identification information of the plurality of ONUs and the port identification information. The network topology information includes a correspondence between the plurality of ONUs and the plurality of third photoelectric ports.

In a possible implementation of the third aspect, the method further includes: The OLT receives an upstream optical signal transmitted by the ODN apparatus. The upstream optical signal carries a first optical power of the ODN apparatus. The upstream optical signal further carries a first optical power of at least one next-level ODN apparatus of the ODN apparatus. The OLT determines the network topology information based on information carried in the upstream optical signal. The network topology information includes level information of the ODN apparatus, level information of the at least one next-level ODN apparatus, and information about levels to which the plurality of corresponding ONUs belong. A larger value of the first optical power and/or downstream optical powers received by the plurality of ONUs indicates a higher level of a corresponding ODN apparatus.

In a possible implementation of the third aspect, the upstream optical signal further carries the downstream optical powers received by the plurality of ONUs connected to the ODN apparatus and downstream optical powers received by the plurality of ONUs connected to the at least one next-level ODN apparatus.

In this possible implementation, the OLT receives the first optical power of the OLT that is sent by the ODN apparatus, the first optical power of the next-level ODN apparatus, downstream optical power received by the plurality of ONUs connected to the ODN apparatus, and the downstream optical powers received by the plurality of ONUs connected to the next-level ODN apparatus. Then, the OLT may determine more network topology information based on these pieces of power information, where the network topology information further includes level information of the ODN apparatus and information about levels to which the plurality of ONUs belong.

In a possible implementation of the third aspect, the method further includes: The OLT receives an upstream optical signal transmitted by the ODN apparatus, where the upstream optical signal carries information about the first optical power of the first optical signal, the second optical power of the second optical signal, the plurality of third optical power of the plurality of third optical signals, and the downstream optical power received by the plurality of ONUs. The OLT determines an optical power loss in a network based on the first optical power, the second optical power, the plurality of third optical powers, and the downstream optical powers received by the plurality of ONUs. The optical power loss in the network includes an optical power loss from the OLT to the ODN apparatus, optical power losses from the first optical port to the second optical port and the third photoelectric port, and optical power losses from the third photoelectric ports to the plurality of ONUs.

In this possible implementation, the OLT receives the first optical power, the second optical power, the third optical power that are sent by the ODN apparatus, and the downstream optical powers received by the plurality of ONUs. Then, the OLT may determine the optical power loss based on these pieces of power information. The optical power loss includes an optical power loss from the OLT to the ODN apparatus, optical power losses from the first optical port to the second optical port and the third photoelectric port, and optical power losses from the third photoelectric ports to the plurality of ONUs.

In a possible implementation of the third aspect, the method further includes: The OLT receives a first upstream optical signal transmitted by the ODN apparatus. The first upstream optical signals carry network address information of the plurality of ONUs and a plurality of first downstream optical powers received by the plurality of ONUs. The OLT determines a target ONU based on the plurality of first downstream optical powers, where the target ONU is an ONU that has a lowest optical power of the plurality of first downstream optical powers. The OLT sends the downstream optical signal to the target ONU, where the downstream optical signal carries the adjustment signal, so that the target ONU sends an electrical signal that carries the adjustment signal to the target ODN apparatus. The adjustment signal indicates the target ODN apparatus to adjust an adjustable optical splitter of the target ODN apparatus, to increase the optical power of the target third optical signal output by the target third photoelectric port. The target third photoelectric port and the target third optical signal correspond to the target ONU. The target ODN apparatus is an ODN apparatus connected to the target ONU or an upper-level ODN apparatus of the ODN apparatus.

In this possible implementation, the OLT adjusts the split ratio of the adjustable optical splitter by sending the downstream optical signal that carries the adjustment signal to the ODN apparatus, to increase the optical power of the downstream optical signal received by the target ONU. This step is performed for a plurality of times, so that powers of optical signals received by the plurality of ONUs in an entire system are more balanced.

In a possible implementation of the third aspect, the method further includes: The OLT receives a second upstream optical signal transmitted by the ODN apparatus, where the second upstream optical signal carries the network address information of the plurality of ONUs and second downstream optical powers received by the plurality of ONUs. The OLT determines the network topology information based on the first downstream optical power and the second downstream optical power, where the network topology information includes the level information of the ODN apparatus.

In this possible implementation, the OLT receives the first upstream optical signal and the second upstream optical signal that are sent by the ODN apparatus. Then, the OLT may determine the network topology information based on the network address information of the plurality of ONUs, the plurality of first downstream optical powers received by the plurality of ONUs, and the second downstream optical powers received by the plurality of ONUs that are carried in the first upstream optical signal and the second upstream optical signal. The network topology information includes the level information of the ODN apparatus.

According to a fourth aspect, an embodiment of this disclosure provides an optical distribution network ODN apparatus. The ODN apparatus includes a first optical splitter and a second optical splitter, and the second optical splitter is an equal ratio optical splitter. The first optical splitter is configured to perform power splitting on a first optical signal sent by an OLT to obtain a second optical signal and a fourth optical signal. The second optical splitter is configured to perform power splitting on the fourth optical signal to obtain a plurality of third optical signals with equal powers. The second optical signal is sent to a lower-level ODN apparatus, and the plurality of third optical signals are sent to the plurality of corresponding ONUs.

In this possible implementation, the first optical signal is split into the second optical signal and the plurality of third optical signals through power splitting performed by the first optical splitter and the second optical splitter. The optical power ratio of the second optical signal and the plurality of third optical signals may be directly determined based on the split ratio of the first optical splitter. The second optical splitter performs power splitting on the fourth optical signal to obtain the plurality of third optical signals, so that the plurality of third optical signals with equal optical powers can be simply and directly provided to the plurality of ONUs.

In a possible implementation of the fourth aspect, the first optical splitter is an adjustable optical splitter whose power splitting ratio is adjustable.

In this possible implementation, the first optical splitter is the adjustable optical splitter. Therefore, an optical power ratio of the second optical signal and an optical power ratio of the plurality of third optical signals may be simply and efficiently adjusted by directly adjusting a split ratio of the first optical splitter.

According to a fifth aspect, an embodiment of this disclosure provides a passive optical network PON network system. The PON network system includes a plurality of ODN apparatuses, a plurality of ONUs, and an OLT. The ODN apparatus is a structure in the first aspect, and the plurality of ODN apparatuses, the plurality of ONUs, and the OLT are configured to perform the signal processing methods in the second aspect to the fourth aspect.

According to a sixth aspect, an embodiment of this application provides a signal processing method. The method is applied to the passive optical network PON network system in the fifth aspect, and the method includes the signal processing method applied to an ODN apparatus in the second aspect and the signal processing method applied to an OLT in the third aspect.

According to a seventh aspect, an embodiment of this disclosure provides an OLT. The OLT includes a processor and an optical transceiver. The processor is connected to the optical transceiver, and is configured to perform the method described in any one of the second aspect or the specific implementations of the second aspect. The optical transceiver is configured to complete a function of receiving an optical signal from an external device and/or sending a signal received from a processor.

It can be learned from the foregoing technical solutions that embodiments of this application have the following advantages: The ODN apparatus transmits information such as identification information of the plurality of ONUs and port identification information to the OLT, so that the OLT determines network topology information based on the information such as the identification information of the plurality of ONUs and the port identification information, where the network topology information includes a correspondence between the plurality of ONUs and the plurality of third photoelectric ports.

### BRIEF DESCRIPTION OF DRAWINGS

FIG. 1 is a network framework diagram of a passive optical network system;

FIG. 2 is a network framework diagram of a passive optical network system according to an embodiment of this disclosure;

FIG. 3 is a first schematic diagram of a structure of an ODN apparatus according to an embodiment of this disclosure;

FIG. 4 is a second schematic diagram of a structure of an ODN apparatus according to an embodiment of this disclosure;

FIG. 5 is a schematic diagram of a scenario of a passive optical network system according to an embodiment of this disclosure;

FIG. 6 is a third schematic diagram of a structure of an ODN apparatus according to an embodiment of this disclosure;

FIG. 7 is a first signaling flowchart of a signal processing method according to an embodiment of this disclosure;

FIG. 8 is a second signaling flowchart of a signal processing method according to an embodiment of this disclosure;

FIG. 9 is a third signaling flowchart of a signal processing method according to an embodiment of this disclosure;

FIG. 10 is a fourth signaling flowchart of a signal processing method according to an embodiment of this disclosure;

FIG. 11 is a fifth signaling flowchart of a signal processing method according to an embodiment of this disclosure; and

FIG. 12 is a sixth signaling flowchart of a signal processing method according to an embodiment of this disclosure.

### DESCRIPTION OF EMBODIMENTS

Disclosed mbodiments provide an optical distribution network apparatus and a signal processing method to transmit information such as identification information of a plurality of ONUs and port identification information to an OLT by using the ODN apparatus. The information such as the identification information of the plurality of ONUs and the port identification information is used by the OLT to determine network topology information of a PON system.

The following describes embodiments of this disclosure with reference to the accompanying drawings. It is clear that the described embodiments are merely illustrative of some rather than all of embodiments. A person of ordinary skill in the art may learn that, with development of technologies and emergence of new scenarios, technical solutions provided in embodiments are also applicable to similar technical problems.

In the specification, claims, and the accompanying drawings, the terms “first”, “second”, and the like are intended to distinguish between similar objects but do not necessarily indicate a specific order or sequence. It should be understood that these terms may be interchanged in appropriate circumstances so that embodiments described herein can be implemented in an order other than the order illustrated or described. In addition, the terms “including” and any other variant thereof are intended to cover a non-exclusive inclusion. For example, processes, methods, systems, products, or devices that include a series of steps or units are not limited to the steps or the units that are clearly listed, and may include other steps and units that are not clearly listed or that are essential for the processes, methods, products, or devices.

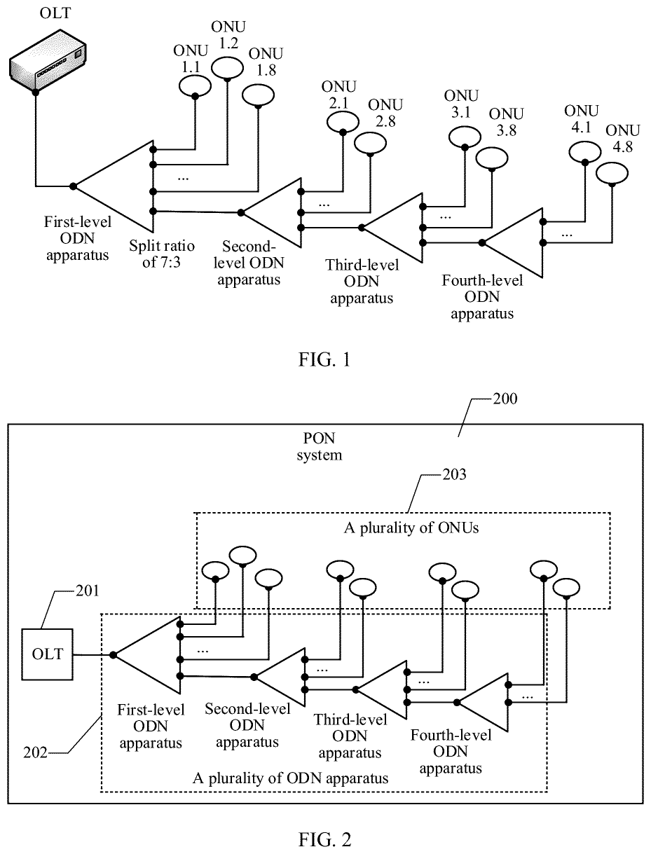

FIG. 1 shows a passive optical network PON system according to an embodiment. As shown in FIG. 1, in the PON system, an OLT transmits one downstream optical signal to a plurality of optical network units (ONUs) through power splitting and transmission of a downstream optical signal performed by an ODN apparatus, so that one-to-many optical interconnection is implemented. In the PON system, the ODN apparatus includes a plurality of optical splitters, and transmits, through power splitting on an optical signal performed by a plurality of optical splitters with a fixed split ratio and transmission in an optical cable, an optical signal sent by one optical line terminal OLT to the plurality of ONUs.

FIG. 2 shows a passive optical network PON system 200 according to an embodiment of this application. As shown in FIG. 2, the PON system 200 includes an optical line terminal OLT 201, a plurality of ODN apparatuses 202, and a plurality of optical network units ONUs 203. The plurality of ODN apparatuses 202 are sequentially connected. An input port of a first-level ODN apparatus (namely, a first ODN apparatus) is connected to an output port of the OLT 201, and an input port of an another-level ODN apparatus is connected to an output port of an upper-level ODN apparatus. One of a plurality of output ports of each ODN apparatus is connected to a next-level ODN apparatus, and other output ports are connected to a plurality of ONUs 203.

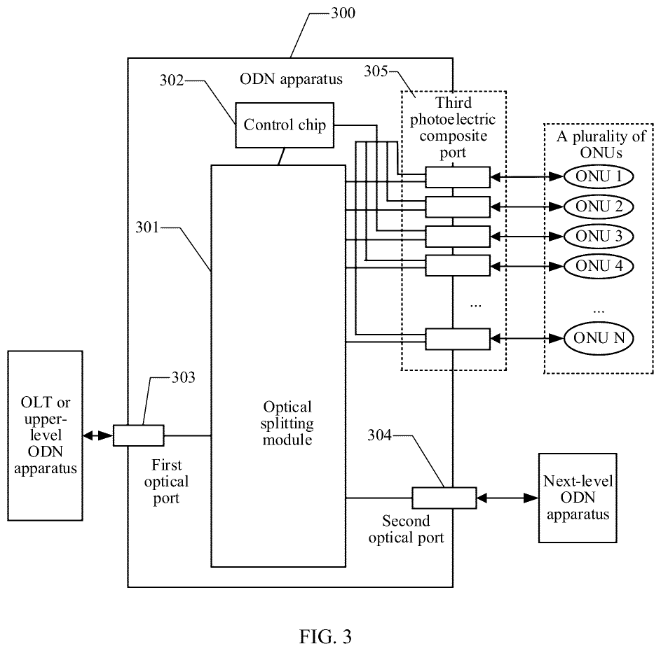

FIG. 3 is a first schematic diagram of a structure of an optical distribution network ODN apparatus 300 according to an embodiment. Embodiment 1: As shown in FIG. 3, in this embodiment of this application, the optical distribution network ODN apparatus 300 includes an optical splitting module 301, a control chip 302, a first optical port 303, a second optical port 304, and a plurality of third photoelectric composite ports 305. The optical splitting module 301 is connected to the control chip 302, the first optical port 303, the second optical port 304, and the plurality of third photoelectric composite ports 305, and the control chip 302 is connected to any photoelectric composite port of the plurality of third photoelectric composite ports 305.

The first optical port 303 is an input port. If the ODN apparatus 300 is an uppermost-level ODN apparatus, namely, a first ODN apparatus, the first optical port 303 is configured to: connect to an optical line terminal OLT, and transmit an optical signal between the ODN apparatus 300 and the OLT. If the ODN apparatus 300 is not the uppermost-level ODN apparatus, the first optical port 303 is configured to: connect to an upper-level ODN apparatus, and transmit an optical signal between the ODN apparatus 300 and the upper-level ODN apparatus.

The second optical port 304 is one of a plurality of output ports of the ODN apparatus 300, and is configured to: connect to a next-level ODN apparatus, and transmit an optical signal between the ODN apparatus 300 and the next-level ODN apparatus.

The plurality of third photoelectric composite ports 305 are output ports of the ODN apparatus 300, and are configured to: connect a plurality of ONUs and the control chip 302, and transmit optical signals between the ODN apparatus 300 and the plurality of ONUs and electrical signals between the control chip 302 and the plurality of ONUs. The third photoelectric composite port is a port that can simultaneously transmit an optical signal and an electrical signal.

The optical splitting module 301 is configured to: receive, through the first optical port 303, a first optical signal sent by the OLT, and split the first optical signal into a second optical signal and a plurality of third optical signals through power splitting. The second optical signal is transmitted to the next-level ODN apparatus through the second optical port 304. The plurality of third optical signals are transmitted to the plurality of corresponding ONUs through the plurality of third photoelectric composite ports 305.

In this embodiment, the OLT generates the downstream first optical signal and sends the downstream first optical signal to a first-level ODN apparatus. After receiving the first optical signal from the first optical port 303, that is, the input interface, the first-level ODN apparatus splits the first optical signal into a second optical signal and a plurality of third optical signals through power splitting performed by the optical splitting module 301. Then, the ODN apparatus transmits the plurality of third optical signals to the plurality of corresponding ONUs through the plurality of third photoelectric composite ports 305, and transmits the second optical signal to the next-level ODN apparatus through the second optical port 304. The next-level ODN apparatus continues to perform the foregoing operations until the optical signal is transmitted to a last-level ODN apparatus.

The control chip 302 is configured to process electrical signals transmitted by the plurality of third photoelectric composite ports 305. The electrical signals may be sent by the plurality of ONUs, or may be sent by the control chip 302 to the ONUs.

In this embodiment, the ODN apparatus 300 may further include a PCB circuit board. The control chip 302 is connected to the plurality of third photoelectric composite ports 305 and the optical splitting module 301 by using the PCB circuit board. The PCB circuit board is configured to transmit electrical signals among the control chip 302, the plurality of third photoelectric composite ports 305, and the optical splitting module 301. In addition, the control chip 302 in this embodiment of this application may be connected to the plurality of third photoelectric composite ports 305 and the optical splitting module 301 in another manner, for example, by using a control circuit that can implement the foregoing functions. This is not specifically limited herein.

In a possible implementation, the PCB circuit board may be further configured to: process the electrical signals transmitted by the plurality of third photoelectric composite ports 305 and the optical splitting module 301, and then transmit the electrical signals to the control chip 302.

The control chip 302 is configured to control the plurality of third photoelectric composite ports 305 to send a plurality of electrical signals that carry port identification information to the plurality of corresponding ONUs. The port identification information indicates identifiers of the plurality of third photoelectric composite ports 305 of the ODN apparatus 300.

Any one of the plurality of ONUs is further configured to: after receiving the electrical signals that are sent by the control chip 302 and that carry the port identification information, record the port identification information and identifiers of the ONUs. Because the plurality of ODNs are in a one-to-one correspondence with the plurality of third photoelectric composite ports 305 that send the port identification information, to be specific, the ONUs record information about correspondences between the ONUs and the third photoelectric composite ports, and the information about the plurality of correspondences may be a plurality of information pairs.

In a possible implementation, the control chip 302 may be further configured to: receive, from the plurality of third photoelectric composite ports 305, electrical signals that are sent by the plurality of ONUs and that carry the identifiers of the plurality of ONUs. After receiving the plurality of electrical signals, the control chip 302 records the identifiers of the plurality of ONUs and port identification information of the corresponding third photoelectric composite ports that transmit the electrical signals. Because the plurality of ODNs are in the one-to-one correspondence with the plurality of third photoelectric composite ports 305 that send the port identification information, the control chip 302 records the information about the plurality of correspondences between the plurality of ONUs and the plurality of third photoelectric composite ports 305. The information about the plurality of correspondences may be the plurality of information pairs. Then, the control chip 302 separately sends, to the corresponding ONUs through the third photoelectric composite ports, electrical signals that carry the information about the plurality of correspondences.

In this embodiment of this application, the information about the plurality of correspondences between the plurality of ONUs and the plurality of third photoelectric composite ports 305 may be recorded in the control chip 302, may be recorded in the plurality of ONUs, or may be recorded in both the control chip 302 and the plurality of ONUs. This is not specifically limited herein.

The plurality of ONUs are further configured to generate a plurality of upstream optical signals based on the information about the correspondences recorded by the ONUs or the information about the correspondences sent by the control chip 302. The plurality of upstream optical signals carry identification information of the ONU that sends the upstream optical signals and corresponding port identification information, that is, the information about the correspondences, and send the upstream optical signals to the ODN apparatus 300.

The ODN apparatus 300 is further configured to: separately receive, by using the optical splitting module 301, upstream optical signals of the plurality of corresponding ONUs from the plurality of third photoelectric composite ports 305, and transmit the upstream optical signals to the OLT, where the plurality of upstream optical signals carry identification information of the ONUs that send the upstream optical signals and port identification information of the plurality of corresponding third photoelectric composite ports that transmit the plurality of upstream optical signals.

The OLT is further configured to: after receiving the plurality of upstream optical signals, determine network topology information based on the identification information of the ONUs that send the upstream optical signals and the port identification information of the plurality of corresponding third photoelectric composite ports that transmit the plurality of upstream optical signals that are carried in the plurality of upstream optical signals. The network topology information includes the information about the correspondences between the plurality of ONUs and the plurality of third photoelectric composite ports 305.

In this embodiment of this application, the identification information of the ONU may be network address information of the ONU. For example, a MAC address or an IP address of the ONU may also be a configured number identifier, a name identifier, or the like. This is not specifically limited herein.

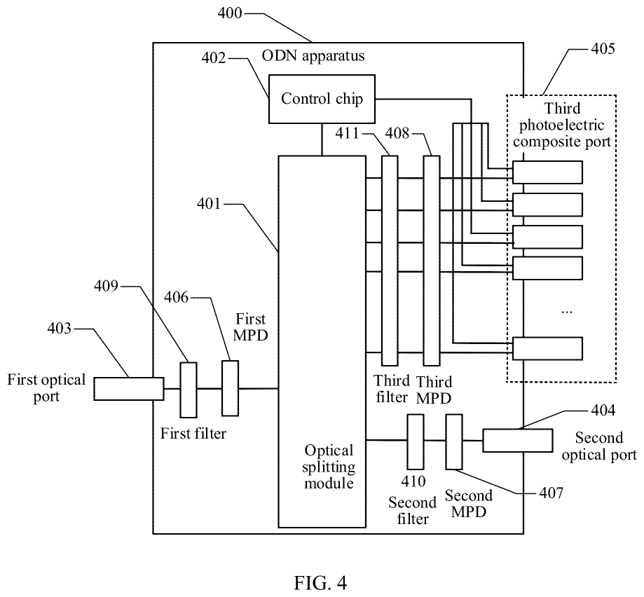

FIG. 4 is a second schematic diagram of a structure of an optical distribution network ODN apparatus 400 according to an embodiment. As shown in FIG. 4, the ODN apparatus 400 further includes a first optical power monitor MPD 406, and the first MPD 406 is connected to a first optical port 403. The first MPD 406 is configured to: obtain a first optical power of a first optical signal, and transmit the first optical power to a control chip 402. The control chip 402 is further configured to control at least one third photoelectric composite port of a plurality of third photoelectric composite ports 405 to send at least one electrical signal that carries the first optical power to at least one ONU of a plurality of ONUs. The at least one ONU is configured to: after receiving the electrical signal that carries the first optical power, generate an upstream optical signal, and send the upstream optical signal to the corresponding ODN apparatus 400. The upstream optical signal of the at least one ONU carries the first optical power.

n optical splitting module 401 of the ODN apparatus 400 is further configured to: separately receive the upstream optical signal of the at least one ONU from the plurality of third photoelectric composite ports 405, and transmit the upstream optical signal to an OLT. The optical splitting module 401 is further configured to: separately receive an upstream optical signal of a next-level ODN apparatus from a second optical port 404, and transmit the upstream optical signal to the OLT. The upstream optical signal of the next-level ODN apparatus carries a first optical power of the next-level ODN apparatus.

In a possible implementation, the upstream optical signal of the at least one ONU further carries an optical power of an optical signal received by the ONU that sends the upstream optical signal, that is, a downstream optical power received by the ONU. The upstream optical signal of the next-level ODN apparatus further carries downstream optical powers received by a plurality of ONUs that are connected to the next-level ODN apparatus.

In a possible implementation, as shown in FIG. 2, if the next-level ODN apparatus is further connected to another lower-level ODN apparatus, the next-level ODN apparatus further transmits, to the OLT, an upstream optical signal sent by the another lower-level ODN apparatus. The upstream optical signal sent by the another lower-level ODN apparatus carries a first optical power of the ODN apparatus that sends the upstream optical signal and/or the downstream optical powers received by the plurality of ONUs that are connected to the another lower-level ODN apparatus.

The OLT is further configured to: receive a plurality of upstream optical signals transmitted by the ODN apparatus 400 and determine network topology information based on information carried in the plurality of upstream optical signals. The network topology information further includes level information of the plurality of ODN apparatuses 400 and information about levels to which the plurality of ONUs belong. In a PON transmission process, each time a downstream optical signal passes through one ODN apparatus 400, a part of the optical signal is obtained through splitting to be sent to the ONU. Therefore, a first optical power of a first optical signal received by each ODN apparatus 400 decreases layer by layer based on levels of a plurality of ODN apparatuses 400. Therefore, after the OLT determines an optical power of an optical signal obtained by the first MPD 406, when a connection position of a first MPD 406 of each ODN apparatus 400 is the same, that is, an optical power of a same optical signal is obtained, the OLT may determine the network topology information of the PON based on sizes of optical powers of optical signals obtained by the plurality of first MPDs 406. The network topology information includes level information of the plurality of ODN apparatuses 400. A larger optical power of the optical signal obtained by the first MPD 406 indicates a higher level of a corresponding ODN apparatus 400. Conversely, a level of the corresponding ODN apparatus 400 is lower.

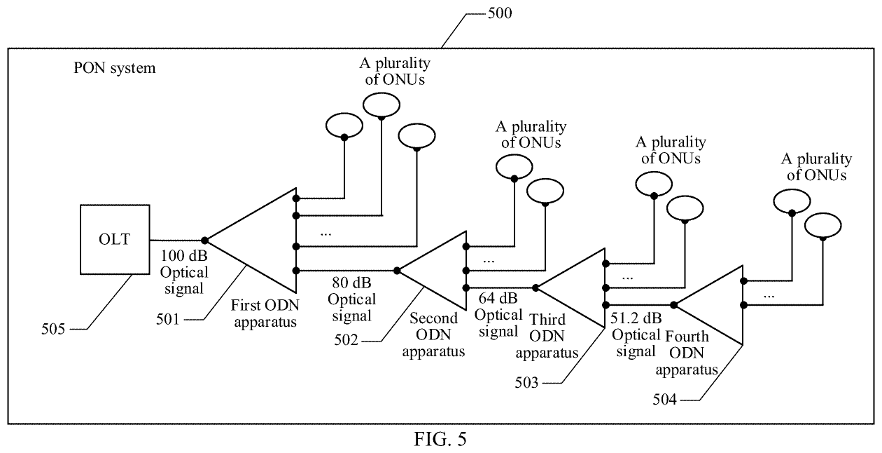

FIG. 5 is a schematic scenario diagram of a PON system according to another disclosed embodiment. As shown in FIG. 5, a split ratio of each ODN apparatus in the PON system 500 is 4:1, and an optical power of an optical signal sent by an OLT 505 received by a first ODN apparatus 501 is 100 dB. After the first ODN apparatus 501 splits the optical signal, an optical power of an optical signal received by a second ODN apparatus 502 is 80 dB. After the second ODN apparatus 502 splits the optical signal, an optical power of an optical signal received by a third ODN apparatus 503 is 64 dB. After the third ODN apparatus 503 splits the optical signal, an optical power of an optical signal received by a fourth ODN apparatus 504 is 51.2 dB. After obtaining a first optical power of each ODN apparatus, the OLT may determine a level of each ODN apparatus based on the first optical power of each ODN apparatus. Based on the first optical power of each ODN apparatus, the OLT may be determined, based on descending order of levels, that levels of the four ODN apparatuses are successively: the first ODN apparatus 501, the second ODN apparatus 502, the third ODN apparatus 503, and the fourth ODN apparatus 504.

In this embodiment, the optical splitting module 401 includes a first optical splitter and a second optical splitter. The first MPD 406 may be connected to an input port of the first optical splitter and is configured to obtain an optical power of the first optical signal. In addition, the first MPD 406 may also be connected to another port in an optical splitter group to obtain an optical power of another optical signal. For example, the first MPD 406 may be connected to a first output port of the first optical splitter, and is configured to obtain an optical power of a second optical signal. The first MPD 406 may be connected to a second output port of the first optical splitter, and is configured to obtain optical powers of optical signals split by the optical splitter group to a plurality of ONUs, that is, a sum of optical powers of a plurality of third optical signals. This is not specifically limited herein.

In this embodiment, the ODN apparatus 400 transmits to the OLT, a first optical power of the ODN apparatus 400, a first optical power of a next-level ODN apparatus, downstream optical powers received by the plurality of ONUs connected to the ODN apparatus 400, and downstream optical powers received by the plurality of ONUs connected to the next-level ODN. In this way, the OLT may determine the network topology information based on these pieces of power information. The network topology information further includes the level information of the ODN apparatus 400 and the information about the levels to which the plurality of ONUs belong.

As shown in FIG. 4, the ODN apparatus 400 further includes a second MPD 407 and a third MPD 408. The second MPD 407 is connected to the second optical port 404, and the third MPD 408 is connected to a plurality of third photoelectric ports. The second MPD 407 is configured to: obtain a second optical power of the second optical signal, and transmit the second optical power to the control chip 402. The third MPD 408 is configured to: obtain third optical powers of the plurality of third optical signals, and transmit the third optical powers to the control chip 402.

The control chip 402 is further configured to: after receiving the second optical power and the third optical powers, control at least one third photoelectric composite port of the plurality of third photoelectric composite ports 405 to send at least one electrical signal that carries the second optical power and the third optical powers to at least one of the plurality of ONUs. The at least one third photoelectric composite port corresponds to the at least one ONU.

The at least one ONU is further configured to: after receiving the electrical signal that carries the second optical power and the third optical powers, generate an upstream optical signal and send the upstream optical signal to the ODN apparatus 400. The upstream optical signal carries the first optical power, the second optical power, the third optical powers, and the downstream optical powers received by the plurality of ONUs.

The optical splitting module 401 is further configured to: separately receive an upstream optical signal of the at least one corresponding ONU from the plurality of third photoelectric composite ports 405, and transmit the upstream optical signal to the OLT. The upstream optical signal carries the first optical power, the second optical power, the third optical powers, and the downstream optical powers received by the plurality of ONUs.

The OLT is further configured to: receive the upstream optical signal, and determine an optical power loss based on the first optical power, the second optical power, and the third optical powers, and the downstream optical powers received by the plurality of ONUs that are carried in the upstream optical signal. The optical power loss includes an optical power loss from the OLT to the ODN apparatus 400, optical power losses from the first optical port 403 to the second optical port 404 and the third photoelectric port, and optical power losses from the third photoelectric ports to the plurality of ONUs.

In a possible implementation, the ODN apparatus 400 further includes a first filter 409, a second filter 410, and a third filter 411. The first MPD 406 is connected to the optical splitting module 401 through the first filter. The second MPD is connected to the optical splitting module 401 through the second filter 410. The third MPD is connected to the optical splitting module 401 through the third filter 411. The first filter 409 is configured to filter an optical signal received by the first MPD 406. The second filter 410 is configured to filter an optical signal received by the second MPD 407. The third filter 411 is configured to filter an optical signal received by the third MPD 408. In this way, the first MPD 406, the second MPD 407, and the third MPD 408 receive only downstream optical signals or receive only upstream optical signals. In this way, more accurate optical power is obtained.

In this embodiment, a filter is added before an MPD so that an optical signal received by the MPD can be filtered. In this way, accuracy of an optical power obtained by the MPD is improved. For MPDs (namely, the third MPDs) connected to the plurality of third photoelectric composite ports of the optical splitting module, when the third filter is configured to enable the third MPD to receive a downstream optical signal, a quantity of third MPDs needs to be equal to a quantity of the plurality of third photoelectric composite ports, and the third MPDs are in a one-to-one correspondence with the plurality of third photoelectric composite ports. When the third filter is configured to enable the third MPD to receive an upstream optical signal, the plurality of third photoelectric composite ports of the optical splitting module may share an MPD, and the quantity of third MPDs may not correspond to output ports of the optical splitting module. For example, the plurality of third photoelectric composite ports may share one MPD to obtain power of the upstream optical signal. In this way, a quantity of MPDs is reduced, implementation costs are reduced, and system complexity is reduced.

In this embodiment, the ODN apparatus 400 further sends the first optical power, the second optical power, the third optical powers, and the downstream optical powers received by the plurality of ONUs to the OLT. In this way, the OLT can determine the optical power loss based on these pieces of power information. The optical power loss includes the optical power loss from the OLT to the ODN apparatus 400, the optical power losses from the first optical port 403 to the second optical port 404 and the third photoelectric port, and the optical power losses from the third photoelectric ports to the plurality of ONUs.

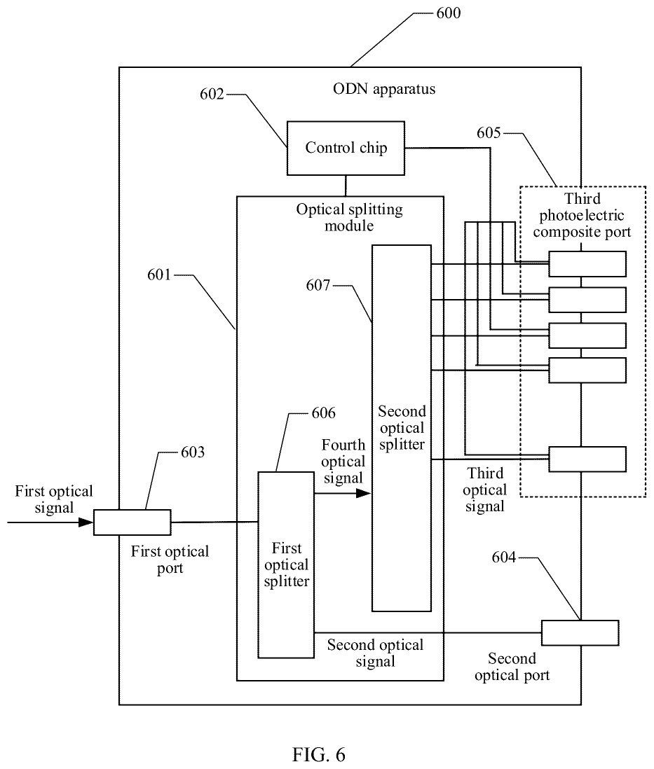

FIG. 6 is a third schematic diagram of a structure of an optical distribution network ODN apparatus 600 according to another of the disclosed embodiments. Embodiment 3: As shown in FIG. 6, an optical splitting module 601 of the ODN apparatus 600 includes a first optical splitter 606 and a second optical splitter 607, and an output port of the first optical splitter 606 is connected to an input port of the second optical splitter 607. The second optical splitter 607 is an equal ratio optical splitter that performs power splitting on an input optical signal to obtain a plurality of output optical signals with equal optical powers. The first optical splitter 606 is configured to perform power splitting on a first optical signal to obtain a second optical signal and a fourth optical signal. The second optical splitter 607 is configured to perform power splitting on the fourth optical signal to obtain a plurality of third optical signals.

In a possible implementation, the first optical splitter 606 is an adjustable optical splitter. The adjustable optical splitter indicates that a power splitting ratio of the optical splitter is adjustable, for example, may be modified from 9:1 to 8:2.

When the first optical splitter 606 is the adjustable optical splitter, a plurality of ONUs are further configured to generate first upstream optical signals after receiving a downstream optical signal sent by an OLT. The first upstream optical signals carry network address information of the plurality of ONUs and a plurality of first downstream optical powers received by the plurality of ONUs. The optical splitting module 601 is further configured to: receive the first upstream optical signals sent by the plurality of ONUs, and transmit the first upstream optical signals to the OLT through a first optical port 603. The OLT is further configured to: receive a plurality of first upstream optical signals transmitted by the ODN apparatus 600, and determine a target ONU based on the plurality of first downstream optical powers carried in the plurality of first upstream optical signals. The target ONU is an ONU corresponding to a downstream optical power with a smallest value of the plurality of first downstream optical powers.

The OLT is further configured to generate a downstream optical signal and send the downstream optical signal to the ODN apparatus 600, where the downstream optical signal indicates the ODN apparatus 600 to transmit the downstream optical signal to the target ONU. The downstream optical signal carries an adjustment signal, and the adjustment signal indicates the ODN apparatus 600 to adjust the adjustable optical splitter, to increase an optical power of a target third optical signal output by a target third photoelectric port. The target third photoelectric port and the target third optical signal correspond to the target ONU.

The ODN apparatus 600 is further configured to: receive the downstream optical signal that carries the adjustment signal, and transmit the downstream optical signal to the target ONU.

The target ONU is configured to: receive the downstream optical signal that is transmitted by the ODN apparatus 600 and that carries the adjustment signal, generate an electrical signal that carries the adjustment signal, and send the electrical signal to the ODN apparatus 600.

The ODN apparatus 600 is further configured to: receive the electrical signal that is sent by the target ONU and that carries the adjustment signal, and adjust the adjustable optical splitter according to an indication of the adjustment signal, to increase the optical power of the target third optical signal output by the target third photoelectric port. The target third photoelectric port and the target third optical signal correspond to the target ONU.

In this embodiment, the power splitting ratio and an optical split ratio of the adjustable optical splitter are adjusted, to increase an optical power of the downstream optical signal received by the target ONU. Through performance for a plurality of times, powers of optical signals received by the plurality of ONUs in an entire system are more balanced.

In this embodiment, the ODN apparatus adjusts the split ratio of the adjustable optical splitter and sends a plurality of adjusted third optical signals to the plurality of corresponding ONUs. The plurality of ONUs are further configured to: generate a plurality of second upstream optical signals, and transmit the plurality of second upstream optical signals to the ODN apparatus 600. The second upstream optical signal carries network address information of the plurality of ONUs and a plurality of second downstream optical powers received by the plurality of ONUs. The second downstream optical powers are powers of downstream optical signals received by the plurality of ONUs after the ODN apparatus adjusts the optical split ratio of the adjustable optical splitter.

The ODN apparatus 600 is further configured to: receive second upstream optical signals sent by the plurality of ONUs, and transmit the second upstream optical signals to the OLT.

The OLT is further configured to: receive a second upstream optical signal that carries the network address information of the plurality of ONUs and the second downstream optical powers received by the plurality of ONUs, and determine network topology information based on the first upstream optical signal and the second upstream optical signal. The network topology information further includes level information of the ODN apparatus 600.

In this possible implementation, the ODN apparatus 600 transmits the first upstream optical signal and the second upstream optical signal to the OLT. In this way, the OLT may determine the network topology information based on the network address information of the plurality of ONUs, the plurality of first downstream optical powers received by the plurality of ONUs, and the second downstream optical powers received by the plurality of ONUs that are carried in the first upstream optical signal and the second upstream optical signal. The network topology information includes the level information of the ODN apparatus 600.

In this embodiment, the ODN apparatus transmits, by using an upstream optical signal to the OLT, information such as identification information of the plurality of ONU, port identification information, a first optical power, a second optical power, a third optical power, and downstream optical powers received by the plurality of ONUs. In this way, the OLT can determine information such as the network topology information and a power loss in a network. The network topology information includes a correspondence between the plurality of ONUs and the plurality of third photoelectric ports, level information of the ODN apparatus, and information about levels to which the plurality of ONUs belong. The OLT determines these pieces of network topology information, to not only perceive a network topology and a device connection status of the entire PON network, to better adjust power allocation of optical signal transmission and reduce a power waste, but also determine a specific faulty node based on these pieces of information when an optical signal transmission fault occurs in the network, to facilitate repairing. In addition, when the ODN apparatus includes the adjustable optical splitter, the adjustable optical splitter may be further adjusted so that the powers of the optical signals received by the plurality of ONUs are more balanced. In this way, the power waste of the optical signals is reduced.

Based on the foregoing PON system, the following describes a signal processing method applicable embodiments of this disclosure.

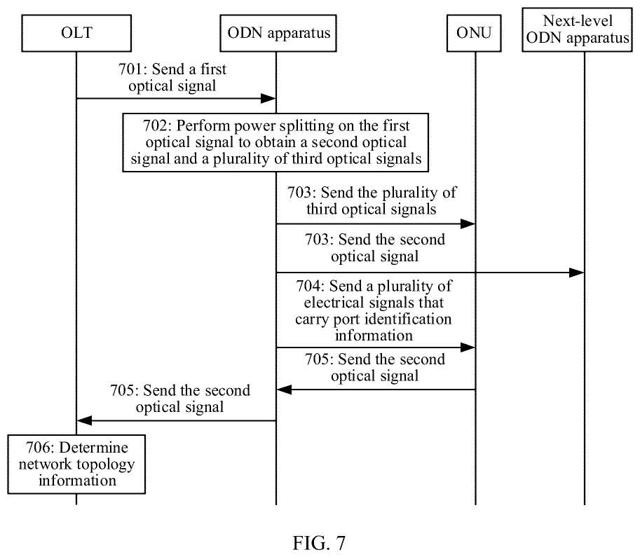

FIG. 7 shows a procedure of a signal processing method according to an embodiment. As shown in FIG. 7, the procedure of the method includes the following plurality of steps.

701: An optical line terminal OLT sends a first optical signal to an ODN apparatus, and correspondingly, the ODN apparatus receives the first optical signal sent by the OLT.

702: The ODN apparatus performs power splitting on the first optical signal to obtain a second optical signal and a plurality of third optical signals.

703: The ODN apparatus transmits the second optical signal to a next-level ODN apparatus, and separately transmits the plurality of third optical signals to a plurality of corresponding ONUs.

704: The ODN apparatus separately sends a plurality of electrical signals that carry port identification information to the plurality of corresponding ONUs, where the port identification information indicates identifiers of a plurality of third photoelectric composite ports.

705: The ODN apparatus separately receives upstream optical signals of the plurality of ONUs, and transmits the upstream optical signals to the OLT, where the upstream optical signals carry identification information of the ONUs that send the upstream optical signals and port identification information of the plurality of corresponding third photoelectric composite ports that transmit the upstream optical signals.

706: The OLT receives the upstream optical signal, and determines network topology information based on the upstream optical signal, where the network topology information includes a correspondence between the plurality of ONUs and the plurality of third photoelectric ports.

In embodiments of this disclosure, the signal processing method is implemented by performing corresponding steps by the OLT, the plurality of ODN apparatuses, and the plurality of ONUs in Embodiment 1. For details, refer to related descriptions in the embodiment shown in FIG. 3. Details are not described herein again.

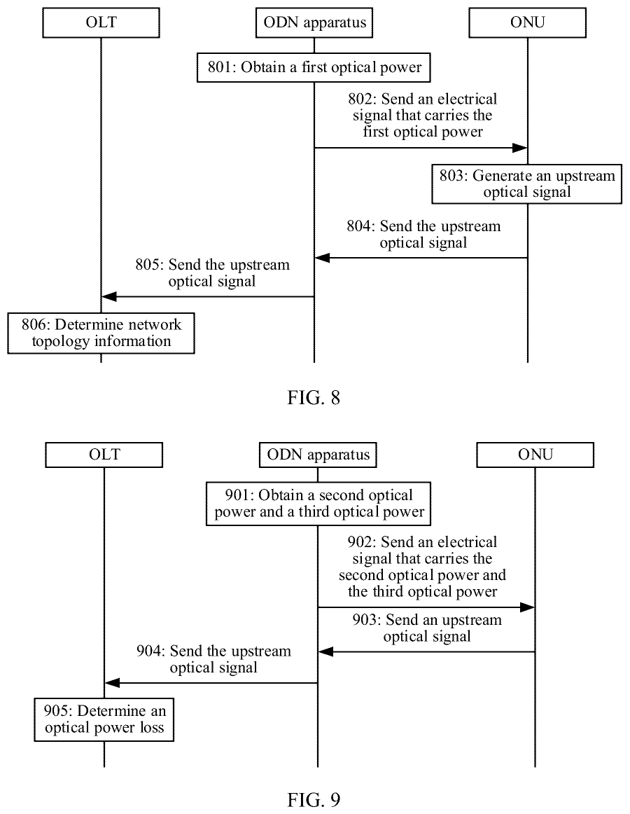

FIG. 8 shows a procedure of a signal processing method according to an embodiment. As shown in FIG. 8, the procedure of the method includes the following plurality of steps.

801: An ODN apparatus determines a first optical power of a first optical signal by using a first MPD.

802: The ODN apparatus separately sends at least one electrical signal that carries the first optical power to at least one ONU of a plurality of ONUs, and correspondingly, the at least one ONU receives the electrical signal that carries the first optical power.

803: The at least one ONU generates an upstream optical signal and sends the upstream optical signal to the ODN apparatus, where the upstream optical signal carries the first optical power.

In a possible implementation, the upstream optical signal sent by the at least one ONU further carries a downstream optical power received by the at least one ONU.

804: The ODN apparatus separately receives an upstream optical signal of the at least one ONU and transmits the upstream optical signal to an OLT.

805: The ODN apparatus receives an upstream optical signal of a next-level ODN apparatus and transmits the upstream optical signal to the OLT, where the upstream optical signal carries a first optical power of the next-level ODN apparatus.

In a possible implementation, the upstream optical signal transmitted by the next-level ODN apparatus further carries downstream optical powers received by a plurality of ONUs connected to the next-level ODN apparatus.

806: The OLT determines network topology information based on the upstream optical signal of the at least one ONU and the upstream optical signal of the next-level ODN apparatus. The network topology information includes level information of a plurality of ODN apparatuses and information about levels to which the plurality of ONUs belong in a PON network.

In embodiments of this application, the signal processing method is implemented by performing corresponding steps by the OLT, the plurality of ODN apparatuses, and the plurality of ONUs in Embodiment 2. For details, refer to related descriptions in the embodiment shown in FIG. 4. Details are not described herein again.

FIG. 9 shows a procedure of a signal processing method according to an embodiment of this application. As shown in FIG. 9, the procedure of the method includes the following plurality of steps.

901: An ODN apparatus obtains a second optical power of a second optical signal and third optical powers of a plurality of third optical signals.

902: The ODN apparatus separately sends a plurality of electrical signals that carry the second optical power and the third optical powers to a plurality of ONUs.

903: The plurality of ONUs generate a plurality of upstream optical signals and transmit the plurality of upstream optical signals to the ODN apparatus, where the upstream optical signals carry a first optical power, the second optical power, the third optical powers, and downstream optical powers received by the plurality of ONUs.

904: The ODN apparatus separately receives the upstream optical signals of the plurality of corresponding ONUs and transmits the upstream optical signals to the OLT.

905: The OLT receives the plurality of upstream optical signals, and determines an optical power loss based on information carried in the upstream optical signals, where the plurality of upstream optical signals carry the first optical power, the second optical power, the third optical powers, and the downstream optical powers received by the plurality of ONUs. The optical power loss includes an optical power loss from the OLT to the ODN apparatus, optical power losses from a first optical port to a second optical port and a third photoelectric port, and optical power losses from the third photoelectric ports to the plurality of ONUs.

In embodiments of this disclosure, the signal processing method is implemented by performing corresponding steps by the OLT, the plurality of ODN apparatuses, and the plurality of ONUs in Embodiment 2. For details, refer to related descriptions in the embodiment shown in FIG. 4. Details are not described herein again.

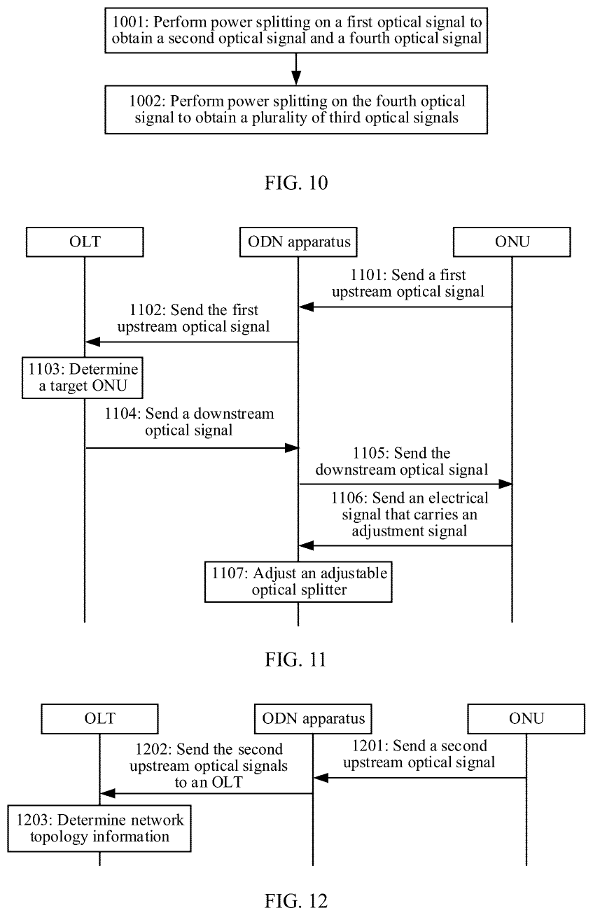

FIG. 10 shows a procedure of a signal processing method according to an embodiment of this application. The foregoing ODN apparatus includes a first optical splitter and an equal ratio optical splitter. As shown in FIG. 10, the procedure of the method includes the following plurality of steps.

1001: The ODN apparatus performs power splitting on a first optical signal to obtain a second optical signal and a fourth optical signal by using the first optical splitter.

1002: The ODN apparatus performs power splitting on the fourth optical signal to obtain a plurality of third optical signals with equal optical powers by using the equal ratio optical splitter.

In embodiments of this disclosure, the signal processing method is implemented by performing corresponding steps by the ODN apparatus in Embodiment 3. For details, refer to corresponding functions of the ODN apparatus in Embodiment 3 shown in FIG. 6. Details are not described herein again.

FIG. 11 shows a procedure of a signal processing method according to an embodiment of this application. The first optical splitter is an optical splitter whose power splitting ratio is adjustable. As shown in FIG. 11, the procedure of the method includes the following plurality of steps.

1101: A plurality of ONUs generate first upstream optical signals, where the first upstream optical signals carry network address information of the plurality of ONUs and a plurality of first downstream optical powers received by the plurality of ONUs.

1102: An ODN apparatus receives a plurality of first upstream optical signals sent by the plurality of ONUs, and transmits the first upstream optical signals to an OLT through a first optical port.

1103: The OLT receives the plurality of first upstream optical signals transmitted by the ODN apparatus, and determines a target ONU based on the plurality of first downstream optical powers carried in the plurality of first upstream optical signals. The target ONU is an ONU corresponding to a downstream optical power with a smallest value of the plurality of first downstream optical powers.

1104: The OLT generates a downstream optical signal and sends the downstream optical signal to the ODN apparatus, where the downstream optical signal indicates the ODN apparatus to transmit the downstream optical signal to the target ONU. The downstream optical signal carries an adjustment signal, and the adjustment signal indicates the target ONU to send the adjustment signal to the ODN apparatus, to increase, by adjusting the adjustable optical splitter, an optical power of a target third optical signal output by a target third photoelectric port. The target third photoelectric port and the target third optical signal correspond to the target ONU.

1105: The ODN apparatus receives the downstream optical signal sent by the OLT, and sends the downstream optical signal to a target ONU indicated by the downstream optical signal.

1106: The target ONU receives a downstream optical signal that is transmitted by the ODN apparatus and that carries the adjustment signal, generates an electrical signal that carries the adjustment signal, and sends the electrical signal to the ODN apparatus.

1107: The ODN apparatus receives the electrical signal that is sent by the target ONU and that carries the adjustment signal, and adjusts the adjustable optical splitter according to an indication of the adjustment signal, to increase the optical power of the target third optical signal output by the target third photoelectric port. The target third photoelectric port and the target third optical signal correspond to the target ONU.

In embodiments of this disclosure, the signal processing method is implemented by performing corresponding steps by the OLT, the plurality of ODN apparatuses, and the plurality of ONUs in Embodiment 3. For details, refer to related descriptions in Embodiment 3 shown in FIG. 6. Details are not described herein again.

FIG. 12 shows a procedure of a signal processing method according to an embodiment of this disclosure. A first optical splitter is an optical splitter whose power splitting ratio is adjustable. After the first optical splitter increases a third optical signal output to a target ONU, as shown in FIG. 12, the procedure of the method includes the following plurality of steps.

1201: A plurality of ONUs generate a plurality of second upstream optical signals and transmit the plurality of second upstream optical signals to an ODN apparatus, where the second upstream optical signals carry network address information of the plurality of ONUs and a plurality of second downstream optical powers received by the plurality of ONUs. The second downstream optical powers are powers of downstream optical signals received by the plurality of ONUs after the ODN apparatus adjusts an optical split ratio of an adjustable optical splitter.

1202: The ODN apparatus receives the second upstream optical signals sent by the plurality of ONUs, and transmits the second upstream optical signals to an OLT.

1203: The OLT receives a second upstream optical signal that carries network address information of the plurality of ONUs and the second downstream optical powers received by the plurality of ONUs, and determines network topology information based on the first upstream optical signal and the second upstream optical signal. The network topology information further includes level information of the ODN apparatus.

In embodiments of this disclosure, the signal processing method is implemented by performing corresponding steps by the OLT, the plurality of ODN apparatuses, and the plurality of ONUs in Embodiment 3. For details, refer to related descriptions in Embodiment 3 shown in FIG. 6. Details are not described herein again.

A person skilled in the art may clearly understand that, for the purpose of convenient and brief description, for detailed working processes of the foregoing system, apparatus, and unit, refer to corresponding processes in the foregoing method embodiments. Details are not described herein again.

In several embodiments provided in this disclosure, it should be understood that the disclosed system, apparatus, and method may be implemented in another manner. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electrical, a mechanical, or another form. The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the essential technical solutions of this disclosure, or the part contributing to a conventional technology, or all or some of the technical solutions may be implemented in the form of a software product. The computer software product is stored in a storage medium and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

What is claimed is:

1. An optical distribution network (ODN) apparatus, comprising:
an optical splitting module;
a control chip;
a first optical port;
a second optical port; and
a plurality of third photoelectric composite ports, wherein the optical splitting module is connected to the control chip, the first optical port, the second optical port, and the plurality of third photoelectric composite ports, wherein:
the first optical port is configured to connect to an optical line terminal (OLT);
the second optical port is configured to connect to a next-level ODN apparatus;
the plurality of third photoelectric composite ports are each configured to connect to a plurality of optical network units (ONUs), and the third photoelectric composite port is configured to transmit an optical signal and an electrical signal;
the control chip is configured to control the plurality of third photoelectric composite ports to separately send a plurality of electrical signals that carry port identification information to the plurality of corresponding ONUs, wherein the port identification information indicates identifiers of the plurality of third photoelectric composite ports;
the optical splitting module is configured to perform power splitting on a first optical signal sent by the OLT to obtain a second optical signal and a plurality of third optical signals, wherein the second optical signal is transmitted to the next-level ODN apparatus, and the plurality of third optical signals are transmitted to the plurality of ONUs; and
the optical splitting module is further configured to: separately receive upstream optical signals of the plurality of corresponding ONUs from the plurality of third photoelectric composite ports, and transmit the upstream optical signals to the OLT, wherein the upstream optical signals carry identification information of the ONUs that send the upstream optical signals and port identification information of the corresponding third photoelectric composite ports that transmit the upstream optical signals.

2. The ODN apparatus according to claim 1, further comprising:
a first optical power monitor (MPD) connected to the first optical port, the first MPD being configured to obtain a first optical power of the first optical signal and to transmit the first optical power to the control chip.

3. The ODN apparatus according to claim 2, wherein the optical splitting module is further configured to:
receive an upstream optical signal of the at least one ONU and to transmit the upstream optical signal to the OLT, wherein the upstream optical signal of the at least one ONU carries the first optical power; and
receive an upstream optical signal of the next-level ODN apparatus from the second optical port and to transmit the upstream optical signal to the OLT, wherein the upstream optical signal of the next-level ODN apparatus carries a first optical power of the next-level ODN apparatus.

4. The ODN apparatus according to claim 3, wherein the upstream optical signal of the at least one ONU further carries a downstream optical power received by the at least one ONU, and the upstream optical signal of the next-level ODN apparatus further carries downstream optical powers received by a plurality of ONUs connected to the next-level ODN apparatus.

5. The ODN apparatus according to claim 2, wherein:
the ODN apparatus further comprises a second MPD and a third MPD, the second MPD being connected to the second optical port, and the third MPD being connected to the plurality of third photoelectric composite ports;
the second MPD is configured to obtain a second optical power of the second optical signal and transmit the second optical power to the control chip;
the third MPD is configured to obtain third optical powers of the plurality of third optical signals, and to transmit the third optical powers to the control chip.

6. The ODN apparatus according to claim 2, wherein the control chip is further configured to control at least one third photoelectric composite port of the plurality of third photoelectric composite ports to send at least one electrical signal that carries the first optical power to at least one ONU of the plurality of ONUs, wherein the at least one third photoelectric composite port corresponds to the at least one ONU.

7. The ODN apparatus according to claim 6, wherein the control chip is further configured to control at least one third photoelectric composite port of the plurality of third photoelectric composite ports to send at least one electrical signal that carries the second optical power and the third optical powers to at least one ONU of the plurality of ONUs, wherein the at least one third photoelectric composite port corresponds to the at least one ONU; and
the optical splitting module is further configured to receive an upstream optical signal of the at least one ONU and to transmit the upstream optical signal to the OLT, wherein the upstream optical signal carries the first optical power, the second optical power, the third optical powers, and the downstream optical powers received by the plurality of ONUs.

8. The ODN apparatus according to claim 5, wherein:
the ODN apparatus further comprises a first filter, a second filter, and a third filter, the first MPD is connected to the optical splitting module through the first filter, the second MPD is connected to the optical splitting module through the second filter, and the third MPD is connected to the optical splitting module through the third filter;
the first filter is configured to filter an optical signal received by the first MPD;
the second filter is configured to filter an optical signal received by the second MPD; and
the third filter is configured to filter an optical signal received by the third MPD.

9. The ODN apparatus according to claim 1, wherein:
the optical splitting module comprises a first optical splitter and an equal ratio optical splitter, an output port of the first optical splitter is connected to an input port of the equal ratio optical splitter, and the equal ratio optical splitter is an optical splitter that performs power splitting on an input optical signal to obtain a plurality of output optical signals with equal optical powers;
the first optical splitter is configured to perform power splitting on the first optical signal to obtain the second optical signal and a fourth optical signal; and
the equal ratio optical splitter is configured to perform power splitting on the fourth optical signal to obtain the plurality of third optical signals.

10. The ODN apparatus according to claim 9, wherein the first optical splitter is an adjustable optical splitter.

11. A signal processing method, comprising:
receiving, by an optical distribution network (ODN) apparatus, a first optical signal sent by an optical line terminal (OLT);
performing, by the ODN apparatus, power splitting on the first optical signal to obtain a second optical signal and a plurality of third optical signals;
transmitting, by the ODN apparatus, the second optical signal to a next-level ODN apparatus, and separately transmitting the plurality of third optical signals to a plurality of corresponding optical network units (ONUs);
sending, by the ODN apparatus, a plurality of electrical signals that carry port identification information to the plurality of corresponding ONUs, wherein the port identification information indicates identifiers of a plurality of third photoelectric composite ports;
separately receiving, by the ODN apparatus, upstream optical signals of the plurality of ONUs; and
transmitting the upstream optical signals to the OLT, wherein the upstream optical signals carry identification information of the ONUs that send the upstream optical signals and port identification information of the corresponding third photoelectric composite ports that transmit the upstream optical signals, the upstream optical signals including an indication of network topology information comprising a correspondence between the plurality of ONUs and the plurality of third photoelectric composite ports.

12. The method according to claim 11, further comprising:
obtaining, by the ODN apparatus, a first optical power of the first optical signal;
sending, by the ODN apparatus, at least one electrical signal that carries the first optical power to at least one ONU of the plurality of ONUs;
receiving, by the ODN apparatus, an upstream optical signal of the at least one ONU;
transmitting the upstream optical signal to the OLT, wherein the upstream optical signal of the at least one ONU carries the first optical power;
receiving, by the ODN apparatus, an upstream optical signal of the next-level ODN apparatus; and
transmitting the upstream optical signal to the OLT, wherein the upstream optical signal of the next-level ODN apparatus carries a first optical power of the next-level ODN apparatus, the upstream optical signal of the at least one ONU and the upstream optical signal of the next-level ODN apparatus include network topology information comprising level information of the ODN apparatus and information about levels to which the plurality of ONUs belong.

13. The method according to claim 12, wherein the upstream optical signal of the at least one ONU further carries a downstream optical power received by the at least one ONU, and the upstream optical signal of the next-level ODN apparatus further carries downstream optical powers received by a plurality of ONUs connected to the next-level ODN apparatus.

14. The method according to claim 12, further comprising:
obtaining, by the ODN apparatus, a second optical power of the second optical signal;
obtaining, by the ODN apparatus, third optical powers of the plurality of third optical signals;
sending, by the ODN apparatus, at least one electrical signal that carries the second optical power and the third optical powers to at least one ONU of the plurality of ONUs.

15. The method according to claim 14, further comprising:
receiving, by the ODN apparatus, an upstream optical signal of the at least one ONU; and
transmitting the upstream optical signal to the OLT, wherein the upstream optical signal carries the first optical power, the second optical power, the third optical powers, and the downstream optical powers received by the plurality of ONUs, the upstream optical signal including an indication of optical power loss, wherein the optical power loss comprises an optical power loss from the OLT to the ODN apparatus, optical power losses from a first optical port to a second optical port and a third photoelectric composite port, and optical power losses from the third photoelectric composite ports to the plurality of ONUs.

16. The method according to claim 11, wherein the ODN apparatus comprises a first optical splitter and an equal ratio optical splitter, and the performing, by the ODN apparatus, power splitting on the first optical signal to obtain a second optical signal and a plurality of third optical signals comprises:
performing, by the ODN apparatus using the first optical splitter, power splitting on the first optical signal to obtain the second optical signal and a fourth optical signal; and
performing, by the ODN apparatus using the equal ratio optical splitter, power splitting on the fourth optical signal to obtain the plurality of third optical signals with equal optical powers.

17. The method according to claim 16, wherein the first optical splitter is an optical splitter whose power splitting ratio is adjustable.

18. The method according to claim 11, further comprising:
receiving, by the ODN apparatus, first upstream optical signals sent by the plurality of ONUs;
transmitting the first upstream optical signals to the OLT through the first optical port, wherein the first upstream optical signals carry network address information of the plurality of ONUs and a plurality of first downstream optical powers received by the plurality of ONUs;
receiving, by the ODN apparatus, a downstream optical signal sent by the OLT;
sending the downstream optical signal to a target ONU indicated by the downstream optical signal, wherein the downstream optical signal carries an adjustment signal and the target ONU is an ONU that has a lowest first downstream optical power of the plurality of ONUs determined by the OLT; and
receiving, by the ODN apparatus, an electrical signal that is sent by the target ONU and that carries the adjustment signal, wherein the adjustment signal instructs the ODN apparatus to adjust the adjustable optical splitter to increase an optical power of a target third optical signal output by a target third photoelectric composite port, the target third photoelectric composite port and the target third optical signal corresponding to the target ONU.

19. The method according to claim 11, further comprising:
receiving, by the ODN apparatus, second upstream optical signals sent by the plurality of ONUs and transmitting the second upstream optical signals to the OLT, wherein the second upstream optical signals carry the network address information of the plurality of ONUs and second downstream optical powers received by the plurality of ONUs, the first upstream optical signal and the second upstream optical signal include network topology information comprising the level information of the ODN apparatus.

20. A signal processing method, comprising:
sending, by an optical line terminal (OLT), a first optical signal to an optical distribution network (ODN) apparatus;
receiving, by the OLT, a plurality of upstream optical signals that are sent by a plurality of ONUs and that are transmitted by the ODN apparatus, wherein the plurality of upstream optical signals carry port identification information and a plurality of pieces of network address information of the plurality of corresponding optical network unit (ONU) s, the port identification information indicating identifiers of a plurality of third photoelectric composite ports that are connected to the plurality of ONUs and that are of the ODN apparatus; and
determining, by the OLT, network topology information based on the port identification information and the plurality of pieces of network address information, wherein the network topology information comprises information about a correspondence between the plurality of ONUs and the plurality of third photoelectric composite ports.
